(19) United States
(12) Patent Application Publication
(10) Pub. No.: US 2023/0151745 A1
(43) Pub. Date: May 18, 2023

(54) CLEANING SYSTEM FOR VEHICLE OIL CIRCUIT

(71) Applicant: NINE CIRCLE TAIWAN CO., LTD., Taichung City (TW)

(72) Inventor: Li-Chu Liu, Taichung City (TW)

(21) Appl. No.: 17/529,309

(22) Filed: Nov. 18, 2021

(51) Int. Cl. F01M 11/03; B01D 29/11; B01D 35/18; B01D 35/02

(52) U.S. Cl. CPC F01M 11/03; B01D 29/11; B01D 35/18; B01D 35/02

(57) ABSTRACT

A cleaning system for a vehicle oil circuit is provided, including a heat exchange unit. The heat exchange unit includes an oil inlet channel, a first container, a second container and an oil outlet channel. The first container is located within the second container. The first container defines a first space communicated with the oil inlet channel and the oil outlet channel, and the first container and the second container define a second space therebetween and non-communicated with the first space. The oil inlet channel guides an oil from the vehicle oil circuit to the first space, and the oil outlet channel discharges the oil from the first space. The first space receives the oil, and the second space receives a detergent. When the oil is in the first space, a heat of the oil is transferred to the detergent through the first container.

### BACKGROUND OF THE INVENTION

### Field of the Invention

The present invention relates to a cleaning system for a vehicle oil circuit.

### Description of the Prior Art

Engine oil is used for lubrication, sealing, cooling, cleaning and rust prevention. Specifically, the engine oil may be used to prevent abrasion between adjacent moving parts, form an oil film between surfaces of pistons and cylinders to avoid gas penetration, serve as a cooling agent, remove carbon deposition and oil sludge from the engine, or coat on metal parts to inhibit oxidation.

However, the oil sludge may deposit in the engine (such as the crankcase) and the vehicle oil circuit in long-term use, which may decrease effects of the engine oil, such as cooling, cleaning and lubrication effects, and influence operation of the vehicle.

The present invention is, therefore, arisen to obviate or at least mitigate the above-mentioned disadvantages.

### SUMMARY OF THE INVENTION

The main object of the present invention is to provide a cleaning system for a vehicle oil circuit, which can use a waste heat of oil from the vehicle oil circuit to warm a detergent so as to increase decontamination effect of the detergent.

To achieve the above and other objects, the present invention provides a cleaning system for a vehicle oil circuit, including a heat exchange unit. The heat exchange unit includes an oil inlet channel, a first container, a second container and an oil outlet channel. At least a portion of the first container is located within an interior of the second container. The first container defines a first space, and the second container and the first container define a second space therebetween. The first space is non-communicated with the second space, and the first space is communicated with the oil inlet channel and the oil outlet channel. The oil inlet channel is configured to guide an oil from the vehicle oil circuit to the first space, and the oil outlet channel is configured to discharge the oil from the first space. The first space is configured to receive the oil, and the second space is configured to receive a detergent. When the oil is in the first space, a heat of the oil is transferred to the detergent through the first container.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a drawing showing an arrangement according to a preferable embodiment of the present invention;

FIG. 3 is a stereogram of a heat exchange unit according to a preferable embodiment of the present invention;

FIG. 4 is a breakdown drawing of FIG. 3;

FIG. 5 is a cross sectional view taken along the line A-A of FIG. 3; and

FIG. 6 is a cross sectional view taken along the line B-B of FIG. 3.

### DETAILED DESCRIPTION OF THE PREFERRED EMBODIMENTS

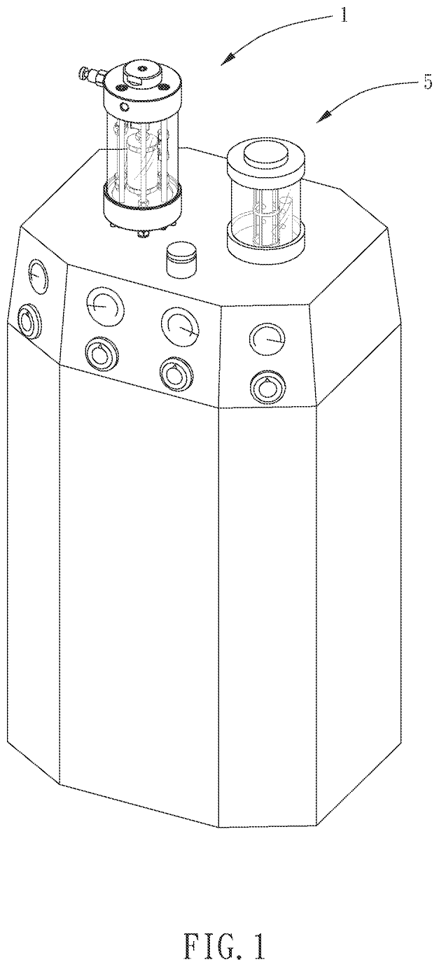

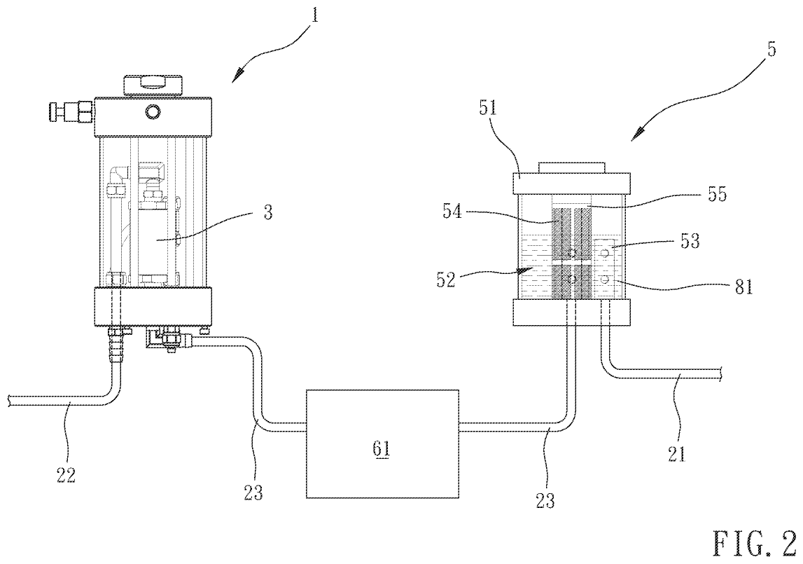

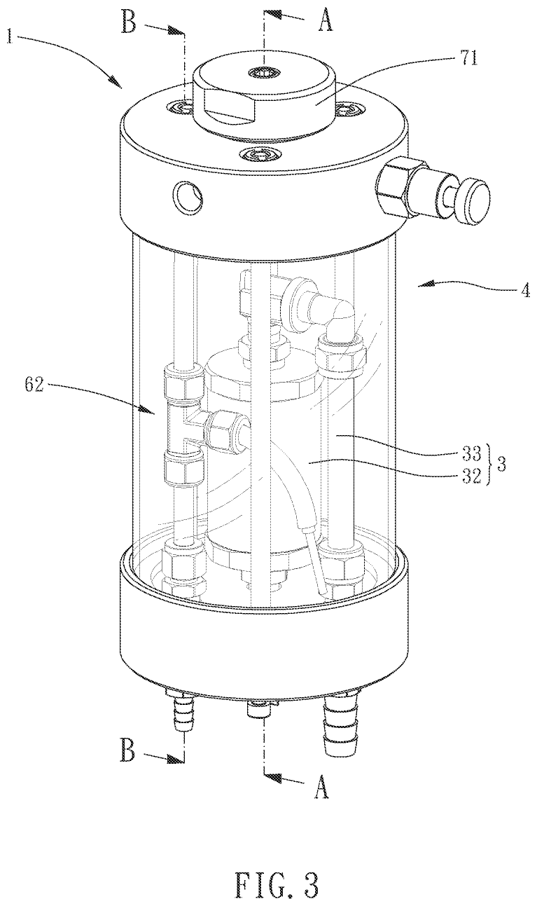

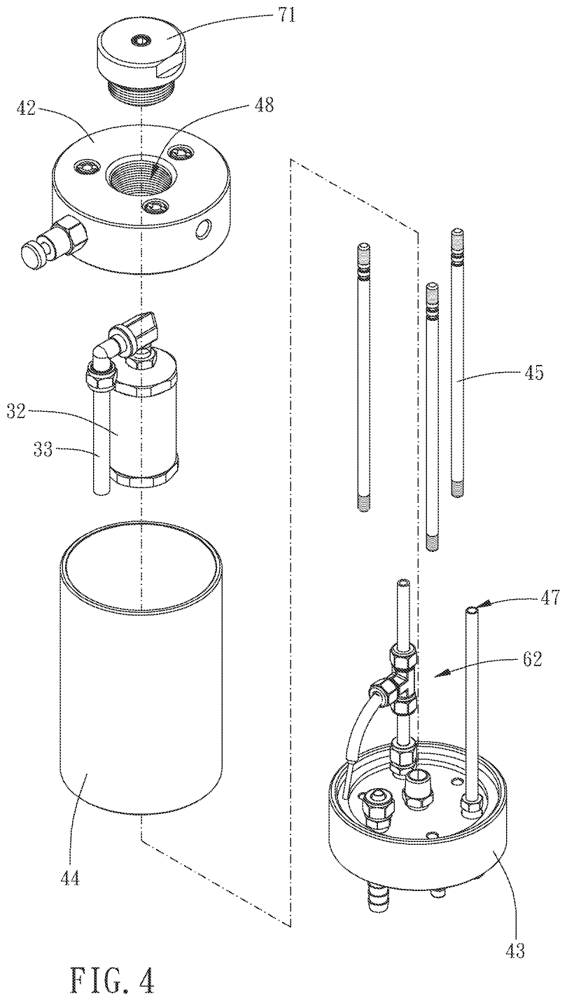

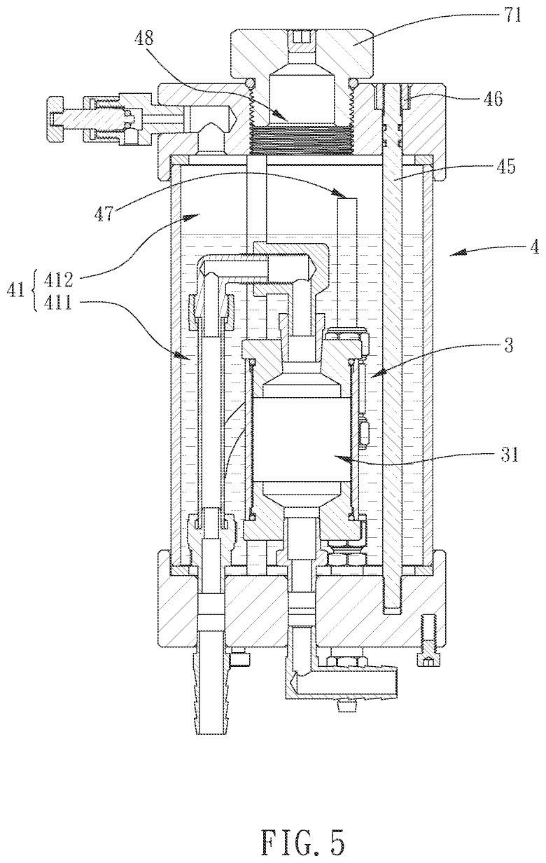

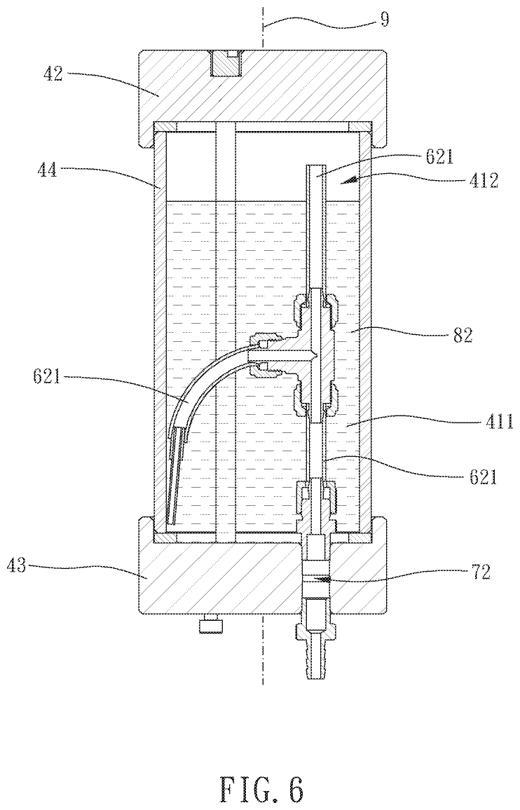

Please refer to FIGS. 1 to 6 for a preferable embodiment of the present invention. A cleaning system for a vehicle oil circuit of the present invention includes a heat exchange unit 1.

The heat exchange unit 1 includes an oil inlet channel 21, a first container 3, a second container 4 and an oil outlet channel 22. At least a portion of the first container 3 is located within an interior of the second container 4. The first container 3 defines a first space 31, and the second container 4 and the first container 3 define a second space 41 therebetween. The first space 31 is non-communicated with the second space 41, and the first space 31 is communicated with the oil inlet channel 21 and the oil outlet channel 22. The oil inlet channel 21 is configured to guide an oil 81 from the vehicle oil circuit to the first space 31, and the oil outlet channel 22 is configured to discharge the oil 81 from the first space 31. The first space 31 is configured to receive the oil 81, and the second space 41 is configured to receive a detergent 82. Understandably, the vehicle oil circuit of a vehicle is cleaned when the vehicle is operating so that a temperature of the oil 81 (such as engine oil) in the vehicle oil circuit is higher than a room temperature. When the oil 81 is in the first space 31, the heat of the oil 81 is transferred to the detergent 82 through the first container 3 so that the detergent 82 is warmed and activated by the heat of the oil 81 to provide good decontamination effect.

In this embodiment, the first container 3 is entirely disposed within the second space 41 so as to increase a contact area of the first container 3 with the detergent 82. Specifically, the first container 3 includes a communication segment 33 and an enlarged segment 32 communicated with each other, and a diametrical dimension of the enlarged segment 32 is larger than a diametrical dimension of the communication segment 33. Therefore, the enlarged segment 32 provides a large space to receive the oil 81 and slow down a flow rate of the oil 81 so as to have sufficient time for heat exchange. Moreover, the enlarged segment 32 is communicated with the oil inlet channel 21 to receive the oil 681 with a higher temperature, and the communication segment 33 is communicated with the oil outlet channel 22 to discharge the oil 81.

Preferably, the enlarged segment 32 is made of a material with a thermal conductivity greater than 60 W/m·K for rapid heat transfer and good heat exchange efficiency. For example, the enlarged segment 32 may be made of metal, such as copper, aluminum, iron, or the like.

Specifically, the second container 4 further includes a first cover body 42, a second cover body 43, a barrel 44, a plurality of threaded rods 45 and a plurality of nuts 46. The first cover body 42 and the second cover body 43 are disposed on two opposite sides of the barrel 44 in an assembling direction 9. One end of each of the plurality of threaded rod 45 is screwed to the second cover body 43, and the other end of each of the plurality of threaded rods 45 is screwed to the first cover body 42. The plurality of nuts 46 are screwed to the plurality of threaded rod 45 and abutted against the first cover body 42 so as to urge the first cover body 42 and the second cover body 43 to move in a direction toward each other and be biased against the barrel 44 for tight connection. In this embodiment, the first container 3 is positioned on the second cover body 43; a number of the plurality of threaded rod 45 is three, and the plurality of threaded rods 45 are disposed in the second container 4 and arranged at equal angular intervals about the first container 3.

The cleaning system for the vehicle oil circuit further includes an atomizing unit 62, and the second container 4 includes a gas inlet channel 47. When the second space 41 is partially filled with the detergent 82, a portion of the second space 41 filled with the detergent 82 defines a liquid region 411, a portion of the second space 41 without the detergent 82 defines a gas region 412. The gas inlet channel 47 is communicated with the gas region 412, and the atomizing unit 62 includes three communication tubes 621 communicated with one another. One of the three communication tubes 621 is communicated with the gas region 412, another of the three communication tubes 621 is communicated with the liquid region 411, and the other of the three communication tubes 621 is configured to be communicated with an outlet 72. For using the detergent 82, a high pressure gas is supplied into the second space 41 through the gas inlet channel 47, and the high pressure gas urges the detergent 82 to flow into the atomizing unit 62. At the same time, a portion of the high pressure gas is supplied into the atomizing unit 62, and the detergent 82 in the atomizing unit 62 is dispersed and atomized by the high pressure gas. Then, the detergent 82 being atomized is discharged from the outlet 72 for cleaning operation.

In this embodiment, the atomizing unit 62 is located at a side of the plurality of threaded rods 45, and the gas region 412 is located above the liquid region 411 based on a ground. Furthermore, the second container 4 further includes a liquid inlet 48 communicated with the second space 41 so that an operator can add the detergent 82 into the second container 4 through the liquid inlet 48. A plug member 71 is detachably screwed to a peripheral wall defining the liquid inlet 48 so as to close the liquid inlet 48.

The cleaning system for the vehicle oil circuit further includes a filter unit 5, and the filter unit 5 is communicated between the oil inlet channel 21 and the first container 3. In this embodiment, an end of the oil inlet channel 21 is configured to be communicated with an insertion hole of an oil level gauge of the vehicle oil circuit, and an end of the oil outlet channel 22 is configured to be communicated with an inlet of an engine oil of the vehicle oil circuit. Therefore, the oil 81 is circulated repeatedly in a circulation loop formed by the vehicle oil circuit, the filter unit 5 and the heat exchange unit 1, and the filter unit 5 can filter off oil sludge or impurities in the oil 81. The oil 81 which is filtered is guided to the heat exchange unit 1 for heat exchange, then returned to the vehicle oil circuit, which can heat the detergent 82 and clean the vehicle oil circuit simultaneously.

Specifically, the filter unit 5 includes a third container 51, a first oil tube 53, a filter member 55 and a second oil tube 54. The third container 51 defines a third space 52, and the heat exchange unit 1 further includes a communication channel 23 communicated between the first container 3 and the third container 51. One end of the first oil tube 53 is communicated with the oil inlet channel 21, and the other end of the first oil tube 53 is communicated with the third space 52. One end of the second oil tube 54 is communicated with the communication channel 23, and the other end of the second oil tube 54 is communicated the third space 52. The filter member 55 covers an opening of the second oil tube 54. The first oil tube 53 is configured to guide the oil 81 in the oil inlet channel 21 to the third space 52, and the second oil tube 54 is configured to guide the oil 81 in the third space 52 to the communication channel 23.

Specifically, the filter member 55 is cylindrical, and the filter member 55 and the second oil tube 54 are coaxially arranged so as to have good filter efficiency. A sidewall of the third container 51 is transparent so that the third space 52 is viewable and convenient to clean. Moreover, the cleaning system for the vehicle oil circuit further includes a driving member 61. The driving member 61 is communicated between the filter unit 5 and the first container 3, and the driving member 61 is configured to drive the oil 81 to move from the filter unit 5 toward the heat exchange unit 1. In this embodiment, the driving member 61 is a pump, and the driving member 61 is communicated between the second oil tube 54 and the first container 3 by the communication channel 23.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cleaning system for a vehicle oil circuit, including:
a heat exchange unit, including an oil inlet channel, a first container, a second container and an oil outlet channel, at least a portion of the first container located within an interior of the second container, the first container defining a first space, the second container and the first container defining a second space therebetween, the first space being non-communicated with the second space, the first space communicated with the oil inlet channel and the oil outlet channel, the oil inlet channel configured to guide an oil from the vehicle oil circuit to the first space, the oil outlet channel configured to discharge the oil from the first space, the first space configured to receive the oil, the second space configured to receive a detergent;
wherein when the oil is in the first space, a heat of the oil is transferred to the detergent through the first container.

2. The cleaning system for the vehicle oil circuit of claim 1, further including a filter unit, wherein the filter unit is communicated between the oil inlet channel and the first container.

3. The cleaning system for the vehicle oil circuit of claim 2, wherein the filter unit includes a third container, a first oil tube, a filter member and a second oil tube, the third container defines a third space, the heat exchange unit further includes a communication channel communicated between the first container and the third container; one end of the first oil tube is communicated with the oil inlet channel, and the other end of the first oil tube is communicated with the third space; one end of the second oil tube is communicated with the communication channel, and the other end of the second oil tube is communicated with the third space; the filter member covers an opening of the second oil tube; and the first oil tube is configured to guide the oil in the oil inlet channel to the third space, and the second oil tube is configured to guide the oil in the third space to the communication channel.

4. The cleaning system for the vehicle oil circuit of claim 2, further including a driving member, wherein the driving member is communicated between the filter unit and the first container, and the driving member is configured to drive the oil to move from the filter unit toward the heat exchange unit.

5. The cleaning system for the vehicle oil circuit of claim 1, wherein the first container includes a communication segment and an enlarged segment communicated with each other, and a diametrical dimension of the enlarged segment is larger than a diametrical dimension of the communication segment.

6. The cleaning system for the vehicle oil circuit of claim 5, wherein the enlarged segment is communicated with the oil inlet channel, and the communication segment is communicated with the oil outlet channel.

7. The cleaning system for the vehicle oil circuit of claim 5, wherein the enlarged segment is made of a material with a thermal conductivity greater than 60 W/m·K.

8. The cleaning system for the vehicle oil circuit of claim 1, wherein the second container further includes a first cover body, a second cover body, a barrel, a plurality of threaded rods and a plurality of nuts, the first cover body and the second cover body are disposed on two opposite sides of the barrel in an assembling direction, one end of each of the plurality of threaded rods is screwed to the second cover body, the other end of each of the plurality of threaded rods is screwed to the first cover body, and the plurality of nuts are screwed to the plurality of threaded rods and abutted against the first cover body.

9. The cleaning system for the vehicle oil circuit of claim 1, further including an atomizing unit, wherein the second container includes a gas inlet channel; when the second space is partially filled with the detergent, a portion of the second space filled with the detergent defines a liquid region, a portion of the second space without the detergent defines a gas region, the gas inlet channel is communicated with the gas region, the atomizing unit includes three communication tubes communicated with one another, one of the three communication tubes is communicated with the gas region, another of the three communication tubes is communicated with the liquid region, and the other of the three communication tubes is configured to be communicated with an outlet.

10. The cleaning system for the vehicle oil circuit of claim 3, further including a driving member, wherein the driving member is communicated between the filter unit and the first container, and the driving member is configured to drive the oil to move from the filter unit toward the heat exchange unit; the first container includes a communication segment and an enlarged segment communicated with each other, and a diametrical dimension of the enlarged segment is larger than a diametrical dimension of the communication segment; the enlarged segment is communicated with the oil inlet channel, and the communication segment is communicated with the oil outlet channel; the enlarged segment is made of a material with a thermal conductivity greater than 60 W/m·K; the second container further includes a first cover body, a second cover body, a barrel, a plurality of threaded rods and a plurality of nuts, the first cover body and the second cover body are disposed on two opposite sides of the barrel in an assembling direction, one end of each of the plurality of threaded rods is screwed to the second cover body, the other end of each of the plurality of threaded rods is screwed to the first cover body, and the plurality of nuts are screwed to the plurality of threaded rods and abutted against the first cover body; the cleaning system for the vehicle oil circuit further includes an atomizing unit, the second container includes a gas inlet channel; when the second space is partially filled with the detergent, a portion of the second space filled with the detergent defines a liquid region, a portion of the second space without the detergent defines a gas region, the gas inlet channel is communicated with the gas region, the atomizing unit includes three communication tubes communicated with one another, one of the three communication tubes is communicated with the gas region, another of the three communication tubes is communicated with the liquid region, and the other of the three communication tubes is configured to be communicated with an outlet; the filter member is cylindrical, and the filter member and the second oil tube are coaxially arranged; the driving member is a pump, and the driving member is communicated between the second oil tube and the first container by the communication channel; a sidewall of the third container is transparent; the first container is entirely disposed within the second space; a number of the plurality of threaded rods is three, the plurality of threaded rods are disposed in the second container and arranged at equal angular intervals about the first container; the atomizing unit is located at a side of the plurality of threaded rods; based on a ground, the gas region is located above the liquid region; the second container further includes a liquid inlet communicated with the second space, a plug member is detachably screwed to a peripheral wall defining the liquid inlet; the enlarged segment is made of metal; an end of the oil inlet channel is configured to be communicated with an insertion hole of an oil level gauge of the vehicle oil circuit, and an end of the oil outlet channel is configured to be communicated with an inlet of an engine oil of the vehicle oil circuit; and the first container is positioned on the second cover body.
